(19) United States
(12) Patent Application Publication
(10) Pub. No.: US 2013/0166649 A1
(43) Pub. Date: Jun. 27, 2013

(54) SYSTEM FOR SOCIAL-BASED FILTERING AND CONTRIBUTED PLAYLIST GENERATION

(71) Applicants: Asaf Atzmon, Tel-Aviv (IL); Sagee Ben-Zedeff, Givatyaim (IL); Rotem Hermon, Tel-Aviv (IL); Alina Dorfman, Ramat Gan (IL); Itamar Atzmon, Kfar Yona (IL)

(72) Inventors: Asaf Atzmon, Tel-Aviv (IL); Sagee Ben-Zedeff, Givatyaim (IL); Rotem Hermon, Tel-Aviv (IL); Alina Dorfman, Ramat Gan (IL); Itamar Atzmon, Kfar Yona (IL)

(21) Appl. No.: 13/556,232

(22) Filed: Jul. 24, 2012

Related U.S. Application Data
(60) Provisional application No. 61/511,133, filed on Jul. 25, 2011.

(51) Int. Cl. H04L 29/08

(52) U.S. Cl. CPC H04L 67/22
USPC 709/204

(57) ABSTRACT

A non-transitory computer readable medium, a system and a method for generating a playlist, the method includes: receiving or detecting social network contextual information indicative of a sharing of a certain media entity between certain social network members; and updating, by a playlist generator, a playlist of media entities to be provided to an entertainment application user in response to the detecting of the social network contextual information. The entertainment application user is virtually linked to at least one of the certain social network members.

### RELATED APPLICATIONS

This patent application claims the priority of U.S. provisional patent Ser. 61/511,133 number filing date Jul. 25 2011 which is incorporated herein by reference.

### BACKGROUND

Many services exist today aiming to provide a personalized experience for the consumption of music, media and entertainment content.

Existing services typically fall into one of the several categories
a. Services that generate a playlist based on semantic filtering of a catalog of items. This semantic filtering is driven from analysis of similarities across properties of the catalog items. E.g. Pandora
b. Services that generate a playlist based on a collaborative filtering of a catalog of items. This collaborative filtering is driven from analysis of behavioral data of users of the service. E.g Last.fm
c. Services that allow users to create and share playlists. A user can create and name a list of songs from a catalog of items and then publish this playlist; other users can search and discover published playlists and consume them. E.g. Songza.com

There are also services that allow a user to select other users of the same service and to then consume music based on items published by those users. E.g. Blip.fm.

There is a need for a system that can understand and filter the social context around the sharing of music and other entertainment content in order to provide a better level of content personalization.

### SUMMARY

According to an embodiment of the invention a method for generating a playlist may be provided and may include: receiving or detecting social network contextual information indicative of a sharing of a certain media entity between certain social network members; and updating, by a playlist generator, a playlist of media entities to be provided to an entertainment application user in response to the detecting of the social network contextual information.

The entertainment application user is virtually linked to at least one of the certain social network members. Thus—the entertainment application user may be a member of the social network of the certain social network members, another user of the entertainment user may be a member of the social network of the certain social network members, the entertainment application user and at least one of the certain social network members may be linked to a common user, and the like.

The certain media may be associated with a certain artist. The method may include updating popularity statistics indicative of a popularity of the certain artist in response to the detecting of the social network contextual information.

The method may include monitoring a behavior of the certain entertainment application user to obtain additional metadata relating to the certain media entity.

The method may include ignoring the social contextual information indicative if it is determined that the social contextual information is not associated with a selected contributor of the entertainment application user.

The method may include selecting a potential contributor in response to a similarity between popularity statistics of the entertainment application user and popularity statistics of the potential contributor and allowing the entertainment application user to select the potential contributor to provide the selected contributor.

The method wherein the selecting of the potential contributor is further responsive to implicit information obtained from a behavior of the entertainment application user in relation to at least one media entity.

The method may include selecting a potential contributor in response to tracking relationships that exit between the entertainment application user and at least one other entertainment application user or social network member.

The method may include selecting the selected contributor in response to a similarity between popularity statistics of the entertainment application user and popularity statistics of the selected contributor.

The method wherein the certain media is associated with a certain song; wherein the method comprises updating popularity statistics indicative of a popularity of the certain song in response to the detecting of the social network contextual information.

The method may include updating the playlist based upon keywords shared between media entities that were previously included in the playlist and at least one newly added media entities.

The method may include processing social network contextual information to determine that the social network contextual information is indicative of the sharing of the certain media entity between certain social network members.

According to an embodiment of the invention a method for detecting a potential contributor for contributing media entities to a playlist may be provided and may include: calculating popularity statistics for an entertainment application user and for multiple other users, the multiple other users comprise at least zero other entertainment application user and at least one social network member that differ from the entertainment application user; wherein the entertainment application user is virtually linked to at least one of the multiple other users; wherein the calculating is at least partly responsive to a detection of social network contextual information indicative of a sharing of a certain media entity between certain social network members; and selecting the potential contributor out of the multiple other users in response to similarities between popularity statistics of the entertainment application user and popularity statistics of each of the multiple other users.

The selecting of the potential contributor may be further responsive to implicit information obtained from a behavior of the entertainment application user in relation to at least one media entity.

The method may include selecting a potential contributor in response to tracking relationships that exit between the entertainment application user and at least one other entertainment application user or social network member.

The method may include selecting the potential contributor to be a selected contributor.

The method may include allowing the entertainment application user to select the potential contributor to provide the selected contributor.

Additional embodiments of the invention include a system arranged to execute any or all of the methods described above, including any stages-and any combinations of same. For example, the system may include a detector for detecting social network contextual information indicative of a sharing of a certain media entity between certain social network members; and a playlist generator arranged to update a playlist of media entities to be provided to an entertainment application user in response to the detecting of the social network contextual information.

Further embodiments of the invention include a computer readable medium that is non-transitory and may store instructions for performing the above-described methods and any steps thereof, including any combinations of same. For example, the computer readable medium may store instructions for: receiving or detecting social network contextual information indicative of a sharing of a certain media entity between certain social network members; and updating, by a playlist generator, a playlist of media entities to be provided to an entertainment application user in response to the detecting of the social network contextual information.

The entertainment application user may be virtually linked to at least one of the certain social network members.

The certain media may be associated with a certain artist and non-transitory computer readable medium stores instructions for updating popularity statistics indicative of a popularity of the certain artist in response to the detecting of the social network contextual information.

The non-transitory computer readable medium may store instructions for monitoring a behavior of the certain entertainment application user to obtain additional metadata relating to the certain media entity.

The non-transitory computer readable medium may store instructions for ignoring the social contextual information indicative if it is determined that the social contextual information is not associated with a selected contributor of the entertainment application user.

The non-transitory computer readable medium may store instructions for selecting a potential contributor in response to a similarity between popularity statistics of the entertainment application user and popularity statistics of the potential contributor and allowing the entertainment application user to select the potential contributor to provide the selected contributor.

The selecting of the potential contributor may be further responsive to implicit information obtained from a behavior of the entertainment application user in relation to at least one media entity.

The non-transitory computer readable medium may store instructions for selecting a potential contributor in response to tracking relationships that exit between the entertainment application user and at least one other entertainment application user or social network member.

The non-transitory computer readable medium may store instructions for selecting the selected contributor in response to a similarity between popularity statistics of the entertainment application user and popularity statistics of the selected contributor.

The certain media may be associated with a certain song; wherein the non-transitory computer readable medium may store instructions for updating popularity statistics indicative of a popularity of the certain song in response to the detecting of the social network contextual information.

The non-transitory computer readable medium may store instructions for updating the playlist based upon keywords shared between media entities that were previously included in the playlist and at least one newly added media entities.

The non-transitory computer readable medium may store instructions for processing social network contextual information to determine that the social network contextual information is indicative of the sharing of the certain media entity between certain social network members.

Further embodiments of the invention include a computer readable medium that is non-transitory and may store instructions for performing the above-described methods and any steps thereof, including any combinations of same. For example, the computer readable medium may store instructions for: calculating popularity statistics for an entertainment application user and for multiple other users, the multiple other users comprise at least one other entertainment application user and at least one social network member that differ from the entertainment application user.

The entertainment application user may be virtually linked to at least one of the multiple other users; wherein the calculating is at least partly responsive to a detection of social network contextual information indicative of a sharing of a certain media entity between certain social network members; and selecting the potential contributor out of the multiple other users in response to similarities between popularity statistics of the entertainment application user and popularity statistics of each of the multiple other users.

The non-transitory computer readable medium that stores instructions for selecting of the potential contributor in response to implicit information obtained from a behavior of the entertainment application user in relation to at least one media entity.

The non-transitory computer readable medium that stores instructions for selecting a potential contributor in response to tracking relationships that exit between the entertainment application user and at least one other entertainment application user or social network member.

The non-transitory computer readable medium may store instructions for selecting the potential contributor to be a selected contributor.

The non-transitory computer readable medium may store instructions for allowing the entertainment application user to select the potential contributor to provide the selected contributor.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a sub-system according to an embodiment of the invention;

FIG. 2 illustrates a sub-system according to an embodiment of the invention;

FIG. 3 illustrates a method according to an embodiment of the invention;

FIG. 4 illustrates a system according to an embodiment of the invention;

FIG. 5 illustrates a method according to an embodiment of the invention;

FIG. 6 illustrates a method according to an embodiment of the invention; and

FIG. 7 is a connectivity graph according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

The term “media entity” can include any audio and/or visual entity such as a song, a clip, and the like. Any reference to a clip may be interpreted as a reference to a song or any other media entity.

There is provided a system, method and computer readable medium for recognizing the wealth of data existing in multiple social networks and for using this data both to aggregate the catalog of content items as well as to filter content based on a social context as means to facilitate a personalized consumption experience.

The system, method and computer readable medium may use said information and additional tools to allow a user to chose and create lists of active contributors that serve as a primary source for the generation of playlists for this user.

The system may include (a) A sub-system for identifying and storing entries relating to music or entertainment data; (b) A sub-system for suggesting potential contributors; and (c) a sub-system for generating a contributed playlist (playlist generated by an approved contributor or curator) of music or entertainment content. Although the following text may refer to a system and sub-system it is noted that each sub-system can be replaced by a sequence of methods stages or by instructions to be executed by a computer, said instructions stored in a non-transitory computer readable medium.

The sub-system for identifying and storing entries relating to music or entertainment data may be adapted to:
a. Execute a process that constantly collects data from multiple online sources. These sources are primarily social networks such as Twitter, Facebook and Google+, but could be other sources such as RSS feeds, blog feeds, etc.
b. Execute a process that analyzes data provided by the aforementioned sources and filters them. The filtering is associated with a set of music and entertainment services supported by the system; examples of such services include YouTube, Soundcloud, Vimeo, Spotify, Deezer and Bandcamp.
c. Execute a process that identifies data as either an entry that me be of interest to the service (match) or not; this matching could be based on a set of criteria including the identification of a supported entertainment service as described above as well as other metadata which may be obtained through information stored in our system or by connecting to said entertainment service or by connecting to a 3^{rd} party metadata service.
d. Execute a process that saves entries of interest into a data store (database). Data stored into the data store includes contextual information around the entry of interest, most notably information about the identity of the user that shard this entry of interest through one of multiple social networks, information about the content of the post this user has created around this entry of interest and information about the music or entertainment content that is associated with this entry of interest.

It should be noted that a subset of said entries may be collected through actions which may be performed within the context of a software application. Such actions include the creation of new posts within the software application and the sharing of content within the software application.

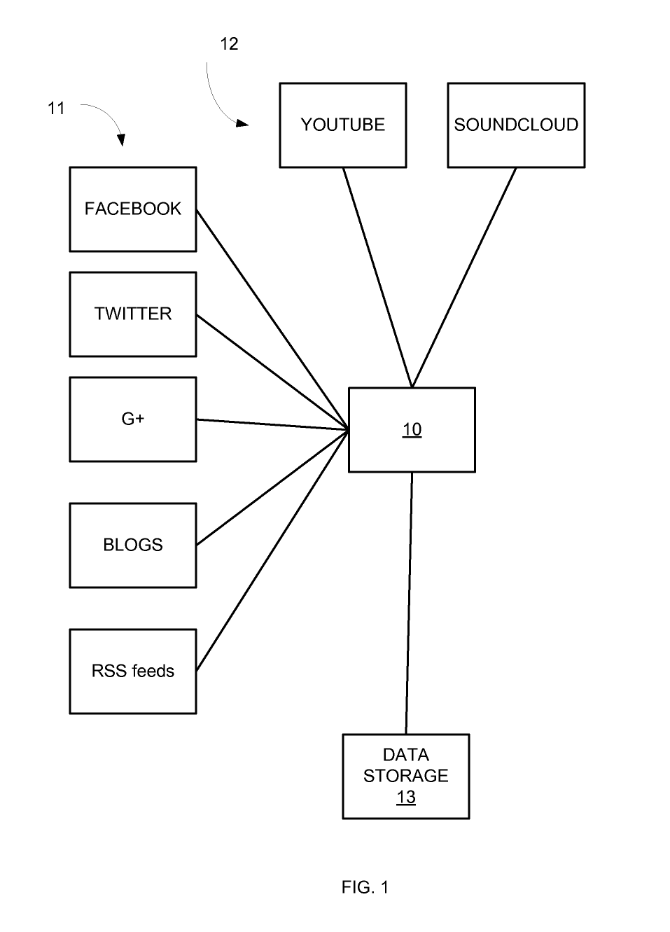

FIG. 1 illustrates a sub-system 10 for identifying and storing entries of interest relating to music or entertainment data according to an embodiment of the invention. Sub-system 10 is coupled to online sources 11 such as Facebook, Twitter, Google plus (G+″), blogs and RSS feeds, and to entertainment services 12 such as YouTube, Soundcloud and the like. Sub-system 10 is also coupled to data storage 13 for storing entries of interest and contextual data.

The sub-system for suggesting potential contributors may be adapted to:
a. Execute a process that profiles users to create an interest graph based on users' taste and preferences related to music or entertainment content. This process could be based on both behavioral data observed through users' actions in the context of the application as well as explicit data provided by the user or through 3^{rd} party sources, such as user's profile in the social network.
b. Execute a process that identifies strong relations between users within multiple social networks. These relations could be analyzed based on several factors such as, but not limited to friends and followers in said multiple social networks, demographic data, geographic data, a 2^{nd} degree of separation between users across the social graph. This process may also identify relations between users based on connections created within the application itself. By way of example, an entertainment application user may choose to connect to another user which may be an entertainment application user or an identity within one of multiple social networks, whether this user is suggested by the system or discovered by other means. This connection made through the system may further aid for the aforementioned analysis and thus would be a supplemental data point allowing the system to identify additional users as potential contributors.
c. Execute a process that identifies strong relations between users within multiple social networks, based on perceived interest graph. These relations could be identified based on users' shared preference to music or entertainment content, such as specific songs, specific artists, specific genres or other similar data sets based on the content semantics as well as behavioral data collected through actions users may take upon the data (such as liking a song or providing some rating to an entertainment content).
d. Execute a process that identifies users as potential contributors for a given entertainment application user. Potential contributors could be other users in the application as well as non-users which have identities in at least one of multiple social networks or blogs. The identification of potential contributors could be based on any of the processes described in this section and would generally be such that have an expected strong affiliation of interest with said entertainment application user.
e. Execute a process that allows an entertainment application user to rate suggested potential contributors. Rating by the entertainment application user could be represented as a binary scalar by which said entertainment application user chooses either to add the suggested potential contributor as an active contributor or not but could also be a more complicated vector or matrix of rating
f. Execute a process that furthermore allows the entertainment application user to manage and organize the list of chosen contributors, whereas such management may include breaking down the list of contributors into multiple sub-lists, tagging active or potential contributors with metadata and rating active or potential contributors.

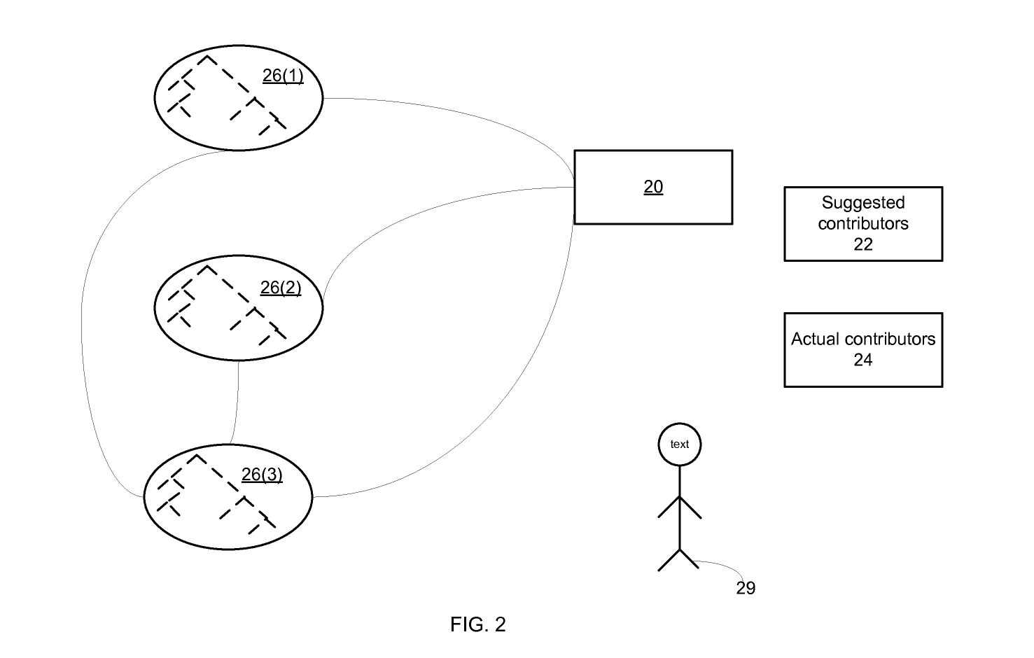

FIG. 2 illustrates a subsystem for suggesting potential contributors 20 according to an embodiment of the invention.

An entertainment application user 29 can review a list of suggested contributors 22 produced by the subsystem for suggesting potential contributors 20. The entertainment application user 29 may either add a suggested potential contributor to his list of active contributors 24 or may reject the suggested potential contributor. The list of suggested contributors 22 may be produced by subsystem for suggesting potential contributors 20 by analyzing social graphs 26(1), 26(2), and 26(3) within multiple social networks and/or between users in a social network and entertainment application users—as illustrated by links 26 that link users of the application to other users in different social networks.

The sub-system for generating a contributed playlist of music or entertainment content be adapted to:
a. Execute a process that generates a playable or viewable playlist for an entertainment application user. This playlist is comprised of entries of interest collected through the processes described in the aforementioned “sub-system for identifying and storing music or entertainment entries of interest”. This playlist may be comprised of entries of interest associated with the set, or any subset, of contributors chosen, organized and rated by said entertainment application user. This playlist may include potential suggested contributors as identified through the processes described in the aforementioned “sub-system for suggesting potential contributors”. The playlist may be comprised of entries of interest associated with a single contributor. The playlist may be comprised of entries of interest sharing common metadata such as a hash tag, a trend, an artist or a genre. The playlist may be comprised of a set or a subset of contributors associated with an entertainment application user different from said entertainment application user (i.e the one consuming the playlist).
b. Execute a process for associating different application resources with a permanent resource locater such as a URL and allows the public or private transfer and sharing of this locater, whereas such resources may include a contributor, a list of contributors, a playlist associated with an entertainment application user or a single entry of interest
c. Execute a process for aggregating multiple entries of interest around a common scheme, whereas this scheme may be entries shared by a single contributor, entries that share a common metadata such as song, artist or genre, entries that relate to a single trend or hashtag

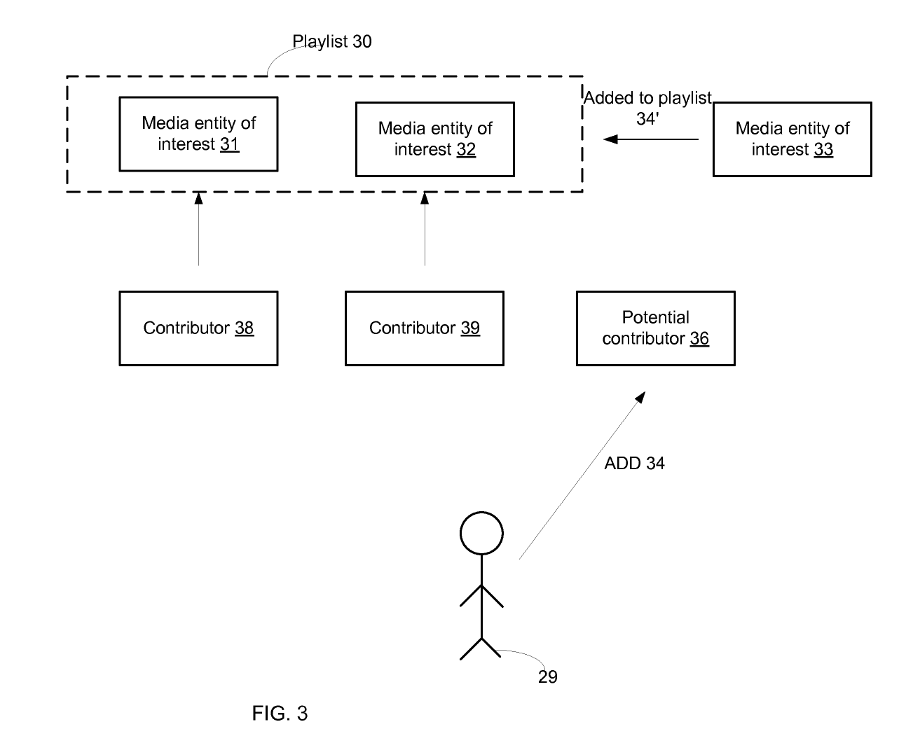

FIG. 3 illustrates a method 30 for generating a contributed playlist of music or entertainment content according to an embodiment of the invention.

The diagram shows a playlist of two media entries that can be regarded as media entity of interest 31 and 32 (e.g. Songs or music clips) associated with two active contributors 38 and 37 of a given entertainment application user 39 as well as with a potential contributor 36 (i.e. not an active contributor of given entertainment application user 39). Media entity of interest 31 and 32 are included in playlist 30 of the given entertainment application user 39. The drawing furthermore describes the entertainment application user 39 adding (“ADD” 34) the potential contributor 36 to his list of active contributors—and this may cause media of interest 33 to be included (“Added to playlist 34′”) in the playlist 30 of the giver entertainment application user 39.

In the following text the terms “clip” will be used. It is noted that the clip can be replaced by other entries of interest relating to music or entertainment data.

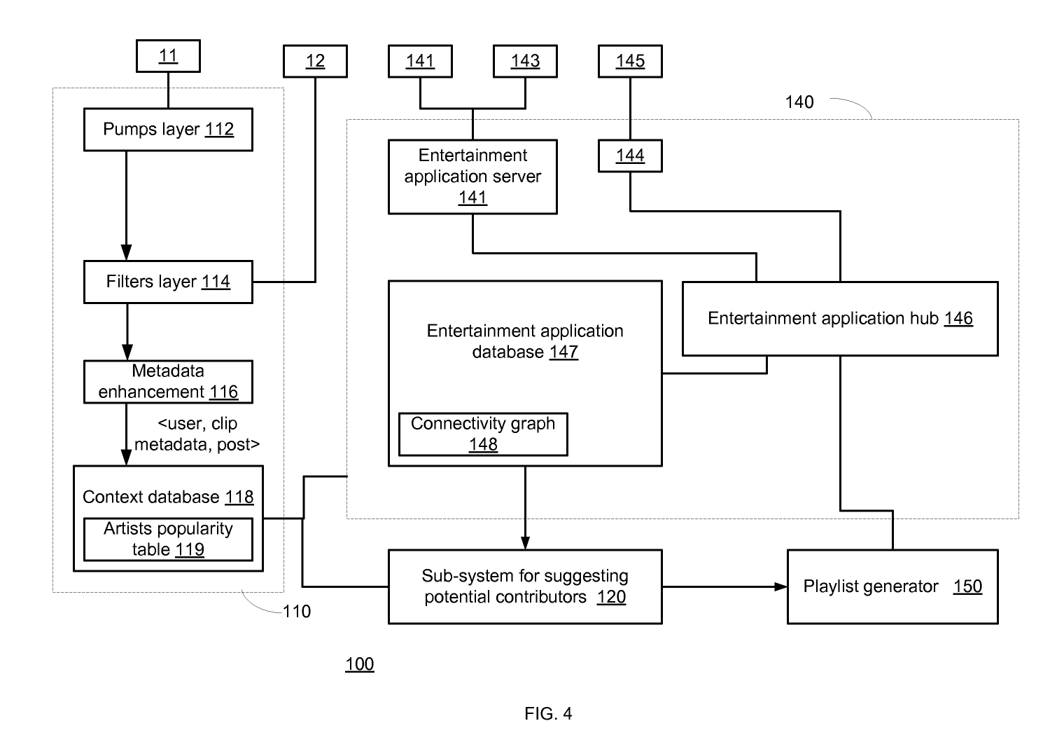

FIG. 4 illustrates the system 100 according to various embodiment of the invention.

According to various embodiments of the invention there is provided a system 100 that includes (a) a sub-system for identifying and storing entries of interest relating to music or entertainment data 110; (b) a sub-system for suggesting potential contributors 120, (c) a sub-system for generating a contributed playlist of music or entertainment content 150, and (d) an front end sub-system 140.

A Sub-System for Identifying and Storing Entries of Interest Relating to Music or Entertainment Data.

The sub-system for identifying and storing entries of interest relating to music or entertainment data 110 includes a pump layer 112, filters layer 114, metadata enhancement layer 116 and context database 118.

Data is accumulated via the pump layer 112 from multiple sources 11 such as twitter, facebook and blogs' RSS feeds. Other pump plug-ins or interfaces to other social networks may also be provided.

Data is then moved to the filters layer 114, and filtered via a set of filters of the filters layer 114, each filter may represent a separate music service or any other entertainment service 12. When a post is processed through the pumps layer 112 it is then distributed across all filters of the filters layer 114, and if a filter is “interested” in the post—identifies the post as relating to a music service it is associated with (e.g. a YouTube filter identifies the post as pointing to a www.youtube.com clip) it takes “ownership” for it.

The filter then communicates with the respective API (e.g. YouTube Data API) to obtain further metadata about the post. At this point, the post may be discarded if the filter chooses so (e.g. not a music post, too long clip etc.).

If the post passes through the filters layer 114, it is then moves to the metadata enhancement’ layer 116 where more structured metadata is being attached to the post/clip (e.g artist name, genre).

Lastly, the full context which may include the post, the clip and the user, is stored into the context database 118. The context database can be analyzed to provide popularity statistics such as artists popularity table 119.

The pump layer 112 may receive data from:
a. Users of the application that share song while executing the application (for example—users of www.serendip.me that share songs.
b. Users of social networks that share songs on their feed (Twitter, Facebook), administrators of Facebook pages that share songs,
c. Bloggers sharing songs on their blog.

The pump layer 112 can gather data that may include a post—metadata that represents the written context that encompasses the shared clip, including the text of the post, the time of posting and the application or website from which this post has been shared.

The social network data can be gathered (or distributed) according to the type of interface with the social networks and the privacy policy enforces by the social networks:
a. For Twitter, where most of the posts are public, the system 100 uses Twitter's search API to gather tweets sharing music from a variety of content services (such as YouTube).
b. For Facebook, where posts are usually limited for friends only, the system 100 uses users feeds to gather posts sharing music from a variety of content services (such as YouTube), as they are shared on the users' feeds.
c. For blogs, the system 100 may process RSS feeds to analyze posts and determine whether they include links to content services supported by the system 100. In that case the system 100 collects the link, along with the post headline, the post text, the post URL, etc.

The filters layer 114 provides a filter per each of content services (such as streaming services). Non-limiting example of content services include YouTube, Vimeo, Soundcloud, and Bandcamp.

The gathered data from the pump layer 112 is filtered using APIs from these streaming services, which among other utilities, typically provide additional metadata about the content itself to verify this is indeed music that can be safely gathered to the context database 118.

The metadata enhancement layer 116 gathers additional metadata about the clips from third party APIs that provide additional metadata such as artist name, song name, relevant album, genre, etc.

According to an embodiment of the invention the resultant set of information is processed and stored into the database in a 3-tuple context of <post, clip metadata, user>:
a. Post—represents the written context that encompasses the shared clip, including the text of the post, the time of posting and the app or website from which this post has been shared.
b. Clip metadata—represents the entertainment (music) content data, including the locater (URL) to the original service (youtube, vimeo etc.), the name of the song, artist, genre etc.
c. User—represent the identity of the user within the social network which could be twitter, facebook, Serendip, a certain blog or any other social network.

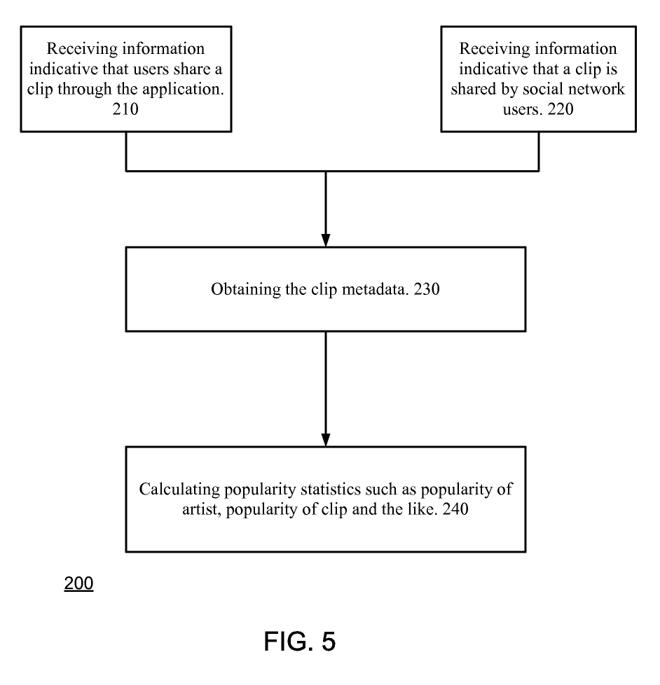

FIG. 5 illustrates a method 200 according to an embodiment of the invention.

Method 200 may start by stages 210 and 220.

Stage 210 may include receiving information indicative that users share a clip through the application.

Stage 220 may include receiving information indicative that a clip is shared by social network users. This stage can be implemented by the pump layer 114 of FIG. 4.

Stage 210 and 220 may include obtaining social network contextual information such as the relevant post and the user. Accordingly—social network contextual information can be gathered during stages 210 and 220.

Stage 210 and 220 may be followed by stage 230 of obtaining the clip metadata.

Stage 230 may be followed by stage 240 of calculating popularity statistics such as popularity of artist, popularity of clip and the like.

The popularity statistics can be calculated per entertainment application users, per social network members or a combination thereof. In this context an entertainment application user (for example—a user of www.serendip.me) that is also a social network member is treated as an entertainment application user. The application can generate more metadata in relation to an entertainment application user in comparison to a social network member that is not an entertainment application user.

Stage 240 can include calculating artist popularity among the entertainment application users, calculating the popularity of artist per each entertainment application user, calculating popularity of a clip among the entertainment application users, calculating the popularity of the clip per each user, calculating popularity of genre per entertainment application user or per group of entertainment application users, calculating artist popularity among the social network members, calculating the popularity of artist per each social network member, calculating popularity of a clip among the social network members, calculating the popularity of the clip per each user, calculating popularity of genre per social network member or per group of social network members and the like. Similar statistics can be calculated per a group of clips, per album, per a group of entertainment application users, per a group of social network members and the like.

For example, stage 240 may include calculating the popularity of multiple artists per entertainment application user (see—table 1) and also calculate the popularity of artist per the entire group of entertainment application users (see—table 2).

TABLE 1

| John Doe (entertainment | |
|---|---|
| application user) | Popularity score of artist per user |
| Madonna | 0.7 |
| Amy Winehouse | 0.631 |
| Sting | 0.4 |

TABLE 2

| | Popularity score of artist per |
|---|---|
| Madonna (Artist) | entertainment application users |
| Mary Smiths (Entertainment | 0.3 |
| application user) | |
| John Doe | 0.7 |

Front End Sub-System 140

The front-end sub-system 140 provides an interface between the entertainment application user and the system 100. The front end sub-system 140 may perform various calculations such as calculating the popularity statistics and the like.

Especially, entertainment application users can browse to an application web site (for example—www.serendip.me) and may receive suggested contributors, may share clips between entertainment application users, may receive playlists and the like.

Referring back to FIG. 4—the front end sub-system 140 may include an application server 142 that process requests from entertainment application user (that may be coupled to the application server via web applications 141 and/or mobile apps 143), as well as an API server 144 which may processes requests from third party apps 145, an entertainment application database 147 for storing information about entertainment application user information such as a connectivity graph 148. All requests may be terminated at the application hub 146.

The front end sub-system 140 may serve playlists to the applications users, the playlists may be fed from the playlists generator 150.

A Sub-System for Suggesting Potential Contributors 120.

This sub-system 120 may maintain and update (constantly or in a non-continuous manner) on each of the entertainment application users, a set of potential contributors. The selection of potential contributors can be based upon one or more strategies, including contributors based on similar taste, or contributors based upon high degree of connectivity.

According to an embodiment of the potential contributors can be calculated based upon the mentioned above popularity statistics—especially artists popularity per entertainment application user or per social network member.

According to an embodiment of the invention additional metadata can be acquired and it can be used to modify the popularity statistics, can replace the popularity statistics or can be used in addition to the popularity statistics.

This additional metadata can be inferred from explicit input from the entertainment application user. The entertainment application user can explicitly indicate his favorite artists and can even provide a popularity score. This explicit information can be provided when the application registers to the application or at other points in time.

Additionally or alternatively, the method can add one or more related artists to the explicit list, thus expanding the user input.

Additionally or alternatively, the additional metadata can be learnt from the behavior of the entertainment application user in relation to clips when the entertainment application user uses the application. Implicit positive and negative actions by the entertainment application user (such as sharing a clip, provision of positive or negative feedback to a clip, a skipping of a clip) can be taken into account and can be used to generate user attributes (such as weights) that can be taken into account when matching the favorite artists (or favorite songs or favorite albums) of an entertainment application user with those of other entertainment application users or social network members to find a potential contributor—that shares at least some of the same favorite artists of the entertainment application user for which the potential contributor is being searched for.

The additional metadata can be used to generate a list of attributes for each entertainment application user and their positive/negative weights. For instance, an aggregated list of artists for each entertainment application user and their likings by this entertainment application user can be generated.

The same logic can be applied to infer not only popular artist for this user, but also popular genres for this user, popular songs, popular albums and the like.

The popularity statistics of a certain entertainment application user and the attributes associated with the entertainment application user can be cross-matched with the popularity statistics of social network members and with popularity statistics and additional metadata (if such exists) of other entertainment application users, for finding other entertainment application users or social network members that liked same artists—as they can be provided as potential contributors.

The system 100 may be arranged to rank other entertainment application users and social network members who liked the same artists, such that the highest rank is the entertainment application user or social network member who shares the most artists with the entertainment application user in question.

This system can update the popularity statistics, obtain additional metadata, and find potential contributors on a periodical basis or in a non-periodical manner. This can be executed for each entertainment application users.

According to another embodiment of the invention a potential contributor can be detected based upon ties between entertainment application users.

In the context of the application, an entertainment application user (following entertainment application user) may choose to create an asymmetric connection to another entertainment application user (followed entertainment application user) which will actively make the followed entertainment application user a contributor in the playlist provided to the following entertainment application user.

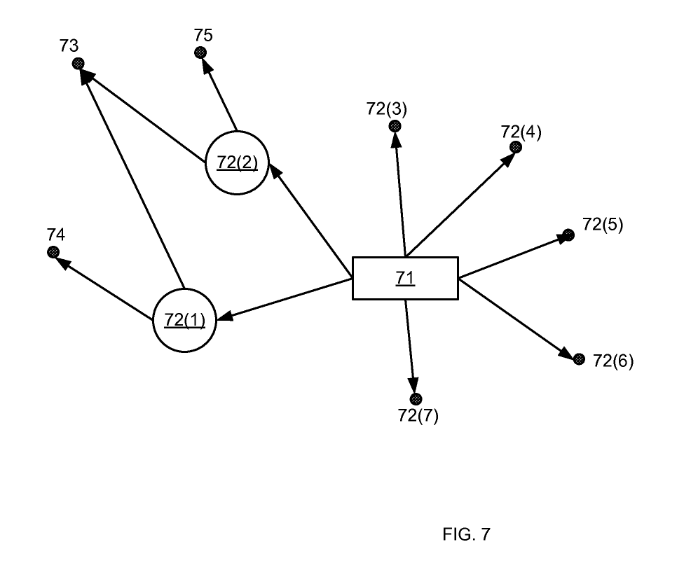

A set of following connections forms a graph where entertainment application users are represented by vortex and each unidirectional edge between two vertices represents a follow relationship between two entertainment application wherein the entertainment application user is virtually linked to at least one of the multiple other users;. FIG. 7 illustrates graph 70 according to an embodiment of the invention.

A certain entertainment application user 71 is following seven contributors 72(1)-72(7) (also referred as DJs). Three contributors 72(1)-72(3) are entertainment application users themselves (encircled). Out of those three entertainment application users two entertainment application users 72(1) and 72(2) follow other contributors—entertainment application user 71(2) follows other contributors 73 and 74 and entertainment application user 71(2) follows other contributors 73 and 75. Neither one of other contributors 73, 74 and 75 is currently regarded as a contributor of certain entertainment application user 71.

Other contributor 73 is shared by the two entertainment application users 72(1) and 72(2), and may be regarded as being virtually linked to the certain entertainment application user 71 at a second degree of connectivity (stated otherwise—two of the contributors of the certain entertainment application users are following a certain other contributor). Assuming that a second degree of connectivity may be taken into account when suggesting potential contributors to the certain entertainment application user 71 then other contributor 73 is marked as a potential curator to the certain entertainment application user. It is noted that according to other embodiment of the invention all other contributors 71, 74 and 75 may be suggested as potential contributors to certain entertainment application user 71.

The system 100 may rank the entertainment application users by the connectivity degree of each vortex. For a given entertainment application user, the system 100 may create a list of all other vertices that are on a second degree connectivity from this vortex users who are followed by users that are followed by the given entertainment application user) and then filter out all these vortices which are also on a first degree connectivity from this vortex—to provide users that the given entertainment application user does not follow and who are followed by entertainment application users that are followed by the given entertainment application user.

The vertices are then sorted according to their degree of connectivity, and the top n'th applications users (vortices) are marked as potential contributors to the user in question. Index n being of a predetermined value.

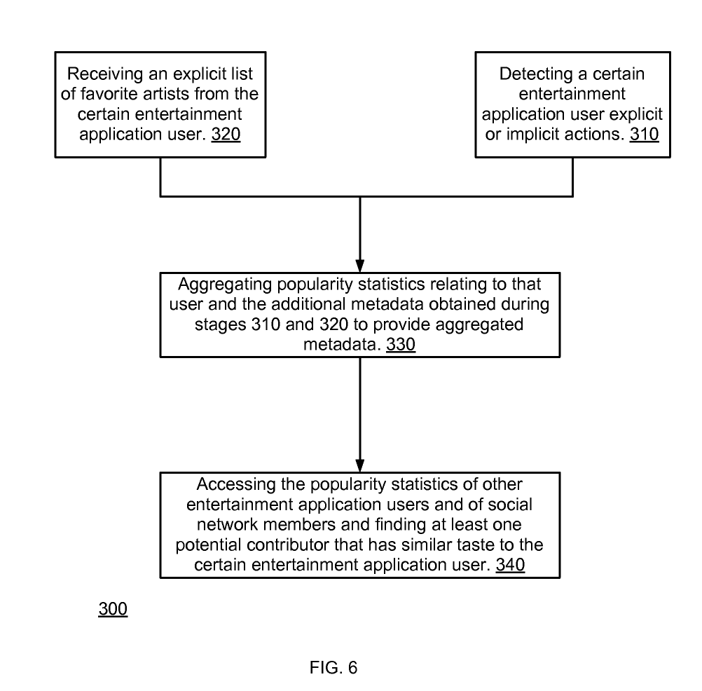

FIG. 6 illustrates a method 300 for suggesting potential contributors according to an embodiment of the invention.

Method 300 is illustrates as being executed to locate potential contributors for a certain entertainment application user.

Method 300 may start by stage 310 and 320. Stage 310 may include detecting a certain entertainment application user explicit or implicit actions. Stage 320 may include receiving an explicit list of favorite artists from the certain entertainment application user.

Stage 310 and 320 may be followed by stage 330 of aggregating popularity statistics relating to that user and the additional metadata obtained during stages 310 and 320 to provide aggregated metadata. Thus, for example, if an entertainment application skips each song of a certain artist the aggregate rank of the artist (for that user) will be reduced or the artist can be ignored of. On the other hand, if the entertainment application user repetitively hears a song of an artist

The popularity statistics can be altered every time the method processes a new event (detection of sharing of a clip). When the method processes a new post p from user u that contains clip c associated with artist a, the popularity table of artist a is updated to include user u (or increase user u counter if he is already in the list), as well as updating the popularity table of user u to include artist a (or increase artist a counter if he is already in the list).

To recommend potential curator c to entertainment application user u1 the method looks at the top artists of entertainment application user u1 (his artist popularity table), as well as looking at the list of favorite artists he explicitly indicated. If this list is smaller than a certain threshold then the method may add to the list more artists which are considered as ‘related in taste’ to the artists aforementioned.

The method them proceeds to look at the popularity tables of all the artists in the lists, and try to find users who score the best through all these tables.

For example if entertainment application u1 list includes Adele, Amy Winehouse, Sting, Kate Bush and U2 the method will try to find the users who are the top users in as many of these artists as possible, so we may find user Joan Doe who is a top user in the tables of Amy Winehouse, U2 and Adele (i.e shares 3 top artists with user u1) and suggest that user as a potential contributor.

Stage 330 is followed by stage 340 of accessing the popularity statistics of other entertainment application users and of social network members and finding at least one potential contributor that has similar taste to the certain entertainment application user.

Each entertainment application user, when presented with one or more potential contributors can select one or more potential contributors to become actual contributors that contribute to the playlist of the entertainment application user.

A Sub-System for Generating a Playlist of Music or Entertainment Content 160

This sub-system is also referred to as playlist subsystem 160. It is arranged to create playlists, which are served to the entertainment application users and may also be provided to third party application, either through the application or via the API.

The playlists may be personalized (requiring the context of a logged-in entertainment application user), or non-personalized.

The playlist generator 160 can be arranged to generate playlists in one or more manners or by a combination of one or more of the following:
a. Generate a playlist for a certain entertainment application user that includes clips shared by one or more contributors that were selected by the certain entertainment application user.
b. Generate a playlist that is aimed for general distribution (not specific to the certain entertainment application user) that includes clips shared by one or more contributors that were selected one or more entertainment application users.
c. Generate playlists for a certain entertainment application user that includes clips shared by one or more potential contributors.
d. Generate a playlist from clips that their clip metadata shares a same keyword or keywords.
e. Generate a playlist from clips that originated from the same social network, were shared during a certain period or were shared between a certain group of social network members. Collect clips that their metadata shares a same keyword or keywords.
f. Generate a playlist from clips that their clip metadata shares a same hash tag or theme (e.g. all songs whose are mentioned in posts and the posts have the hashtag #MusicMonday).
g. Generate a playlist from clips that are associated with the same artists, with the same album, or with the same genre.

In all the examples except for examples a and c—a general playlist can be generated without knowing anything about the entertainment application user who views the playlist (i.e. he doesn't have to be logged to the entertainment application or be recognized. Examples a and c require information about the entertainment application user.

The playlist generator 160 can also take into account the number of actual clips that were obtained using at least one of manners (a)-h) and can either add clips (for example—to reach a playlist that has a length that exceeds a minimal length) or delete clips (for example—to reduce the number of clips to be lower than a maximal number.

The invention may also be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for generating a playlist, the method comprises:
receiving or detecting social network contextual information indicative of a sharing of a certain media entity between certain social network members; and
updating, by a playlist generator, a playlist of media entities to be provided to an entertainment application user in response to the detecting of the social network contextual information.

2. The method according to claim 1, wherein the entertainment application user is virtually linked to at least one of the certain social network members.

3. The method according to claim 1, wherein the certain media is associated with a certain artist; wherein the method comprises updating popularity statistics indicative of a popularity of the certain artist in response to the detecting of the social network contextual information.

4. The method according to claim 1, further comprising monitoring a behavior of the certain entertainment application user to obtain additional metadata relating to the certain media entity.

5. The method according to claim 1, further comprising ignoring the social contextual information indicative if it is determined that the social contextual information is not associated with a selected contributor of the entertainment application user.

6. The method according to claim 5, further comprising selecting a potential contributor in response to a similarity between popularity statistics of the entertainment application user and popularity statistics of the potential contributor and allowing the entertainment application user to select the potential contributor to provide the selected contributor.

7. The method according to claim 6, wherein the selecting of the potential contributor is further responsive to implicit information obtained from a behavior of the entertainment application user in relation to at least one media entity.

8. The method according to claim 5, further comprising selecting a potential contributor in response to tracking relationships that exit between the entertainment application user and at least one other entertainment application user or social network member.

9. The method according to claim 5, further comprising selecting the selected contributor in response to a similarity between popularity statistics of the entertainment application user and popularity statistics of the selected contributor.

10. The method according to claim 1, wherein the certain media is associated with a certain song; wherein the method comprises updating popularity statistics indicative of a popularity of the certain song in response to the detecting of the social network contextual information.

11. The method according to claim 1, further comprising updating the playlist based upon keywords shared between media entities that were previously included in the playlist and at least one newly added media entities.

12. The method according to claim 1 further comprising processing social network contextual information to determine that the social network contextual information is indicative of the sharing of the certain media entity between certain social network members.

13. A method for detecting a potential contributor for contributing media entities to a playlist, the method comprises:
calculating popularity statistics for an entertainment application user and for multiple other users, the multiple other users comprise at least zero other entertainment application user and at least one social network member that differ from the entertainment application user;
wherein the calculating is at least partly responsive to a detection of social network contextual information indicative of a sharing of a certain media entity between certain social network members; and
selecting the potential contributor out of the multiple other users in response to similarities between popularity statistics of the entertainment application user and popularity statistics of each of the multiple other users.

14. The method according to claim 13 wherein the entertainment application user is virtually linked to at least one of the multiple other users.

15. The method according to claim 13, wherein the selecting of the potential contributor is further responsive to implicit information obtained from a behavior of the entertainment application user in relation to at least one media entity.

16. The method according to claim 13, further comprising selecting a potential contributor in response to tracking relationships that exit between the entertainment application user and at least one other entertainment application user or social network member.

17. The method according to claim 13, further comprising selecting the potential contributor to be a selected contributor.

18. The method according to claim 13, further comprising allowing the entertainment application user to select the potential contributor to provide the selected contributor.

19. A non-transitory computer readable medium for generating a playlist, the non-transitory computer readable medium stores instructions for:
receiving or detecting social network contextual information indicative of a sharing of a certain media entity between certain social network members; and
updating, by a playlist generator, a playlist of media entities to be provided to an entertainment application user in response to the detecting of the social network contextual information.

20. The non-transitory computer readable medium according to claim 19, wherein the entertainment application user is virtually linked to at least one of the certain social network members.

21-37. (canceled)
